(19) United States
(12) Patent Application Publication
(10) Pub. No.: US 2024/0428188 A1
(43) Pub. Date: Dec. 26, 2024

(54) METHOD FOR TRACKING PRODUCT HISTORY

(71) Applicant: Hui Lin, Taipei City (TW)

(72) Inventor: Hui Lin, Taipei City (TW)

(21) Appl. No.: 18/824,929

(22) Filed: Sep. 5, 2024

Related U.S. Application Data
(63) Continuation-in-part of application No. 17/607,039, filed on Oct. 28, 2021, now abandoned.

(51) Int. Cl. G06Q 10/087; H04L 9/32

(52) U.S. Cl. CPC G06Q 10/087; H04L 9/3297; G06Q 2220/00

(57) ABSTRACT

A method for tracking a product history includes the steps of: storing a main block chain in a main data storage system and storing an external block chain in an external data storage system; then uploading a plurality of product identifiers of a specific product to the main block chain by a main production and marketing unit which is associated with the product. A plurality of product record blocks are generated based on the product identifiers respectively and stored in the main block chain. In uploading of the product identifiers, a plurality of component record blocks corresponded to a specific component are downloaded from the external block chain by the main production and marketing unit. The component record blocks are uploaded to the main block chain by the main production and marketing unit, and are connected or added to a specific product record block in the main block chain.

The invention is a continuation in part (CIP) of the U.S. patent application Ser. No. 17/607,039 filed at Oct. 28, 2021, invented and assigned to the inventor of the present invention, and thus the contents of the U.S. patent application Ser. No. 17/607,039 is incorporated into the present invention as a part of the specification.

### FIELD OF THE INVENTION

The present invention is related to a product history tracking, in particular to a method for tracking a product history.

### BACKGROUND OF THE INVENTION

In current business society, many merchandises are manufactured and systems for sale of these merchandise are complicated and huge. The divisions of works and cooperation of labors are so complex so that it cannot assure that qualities of final products which sell to the consumers are steady, safe and reliable. Because it is often that the products are not manufactured completely, even some similar products are mixed with real ones. Events, such as changes of labels or barcodes, frequently occur (these events are not confined to foods since foods are directly relative to health of human and life, in this specification, foods are used as examples for descriptions of the invention). One example is to use oil fishes to camouflage as Patagonian toothfishes. These actions will affect business reliability and safety, even affecting health of consumers.

Although current historical data of the products about production processes and sale processes are adapted for showing the processes in manufacturing and sale so as to acquire reliability of consumers, while currently, the historical data of the products are not unified and thus many different specifications are adapted and moreover, they are limited by areas. Furthermore, many authentication mechanisms are concentrated on the processes of manufacturing, managements of the plants, packaging of the products, etc., while information on the upstream supplies are not sufficient. Besides, for importers, based on the managements of resources and market mechanism, pollution of foods is a very important problem, for example, if pollution of Salmonella occurs, it is very difficult to find out which batches of the foods are initial polluted ones. In the past, all batches of the foods are recalled. However, in this process, many foods are wasted.

### SUMMARY OF THE INVENTION

Accordingly, for improving above mentioned defects in the prior art, the object of the present invention is to provide a method for tracking a product history, wherein different block chains are used for storing the identifiers of various components of the product. In the manufacturing of the product, the component identifiers in the producing stages of manufacturing process of each component are uploaded to a corresponding external block chain. When each component is inputted to the main production and marketing unit to be assembled into the product, the component identifiers in each external block chain are respectively loaded into the main production and marketing unit and are uploaded with the product identifiers to the main block chain. Because each identifier represents a respective producing stage of the manufacturing of the component and the product, the identifiers stored in the main block chain can represent a full product history including the full component history. The production and marketing units of these component can use different identifier standards for storing its own component identifiers in a corresponding block chain with a specific identifier standard. By using the external block chain loading device in the main production and marketing unit, the component identifiers of different components can be easily downloaded from different external block chains and uploaded to the main block chain for forming a full product history including the full component history. By uploading the identifiers of product and its components, the historical data of the product and its components can be checked and tracked. As a result, the identifiers of the product and its components are combined with multiple block chains to develop a multi-level product history. The historical data of each component can be searched in a specific product record block of the main block chain, which assures that searching can be performed during processes of manufacturing, warehousing and distributions and sales without being modified. The external block chain for each component also can be accessed by the source block chain address stored with the historical data of each component, which allows a high degree of scalability of the historical data and assuring a high reliability of the quality of the product and its components simultaneously.

To achieve above object, the present invention provides a method for tracking a product history, comprising the steps of: step A: storing a main block chain in a main data storage system and storing an external block chain in an external data storage system; step B: uploading a plurality of product identifiers of a specific product to the main block chain by a main production and marketing unit which is associated with the product; a plurality of product record blocks are generated based on the product identifiers respectively and are stored in the main block chain; and wherein in the step B, in the uploading of the product identifiers, a plurality of component record blocks are downloaded from the external block chain by the main production and marketing unit; the component record blocks are corresponded to a specific component of the product; and the component record blocks are further uploaded to the main block chain by the main production and marketing unit, and are connected or added to a specific product record block in the main block chain.

The present invention further provides a product history tracking system, comprising: a main block chain stored in a main data storage system; an external block chain stored in an external data storage system; a main production and marketing unit which is associated with a specific product; the main production and marketing unit being connected to the main data storage system and the external data storage system; the main production and marketing unit serving to upload a plurality of product identifiers of the product to the main block chain; a plurality of product record blocks generated based on the product identifiers respectively and stored in the main block chain; and wherein when the main production and marketing unit uploads the product identifiers to the main block chain, a plurality of component record blocks are downloaded from an external block chain by the main production and marketing unit; the component record blocks are corresponded to a specific component of the product; and the component record blocks are further uploaded to the main block chain by the main production and marketing unit, and are connected or added to a specific product record block in the main block chain.

### BRIEF DESCRIPTION OF THE DRAWINGS

FIG. 1 is a schematic view showing the block diagram of the main elements of the present invention.

FIG. 2 is a schematic view showing the operation of the present invention.

FIG. 3 is a flow diagram of the present invention.

FIG. 4 is a schematic view showing the main production and marketing unit and the external production and marketing unit of the present invention.

FIG. 5 is a schematic view showing the block diagram of the component record block set of the present invention.

FIG. 6 is a schematic view showing another block diagram of the elements of the present invention.

FIG. 7 is a schematic view showing the main manufacturing process of the main production and marketing unit of the present invention.

FIG. 8 is a schematic view showing the external manufacturing process of the external production and marketing unit of the present invention.

FIG. 9 is a schematic view showing the block diagram of the main production and marketing unit of the present invention.

FIG. 10 is a schematic view showing the block diagram of the external production and marketing unit of the present invention.

FIG. 11 is a schematic view showing the block diagram of the web server, the main data storage system and the external data storage system of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

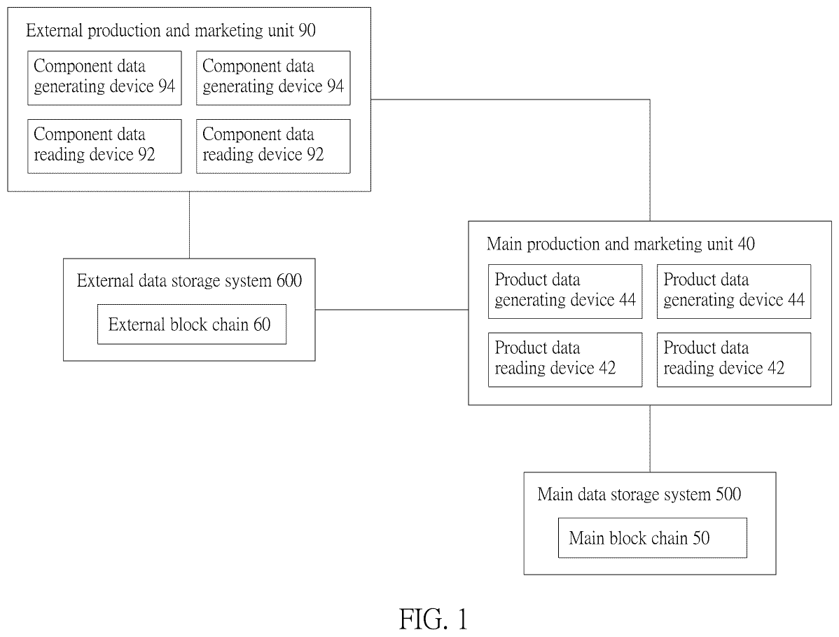

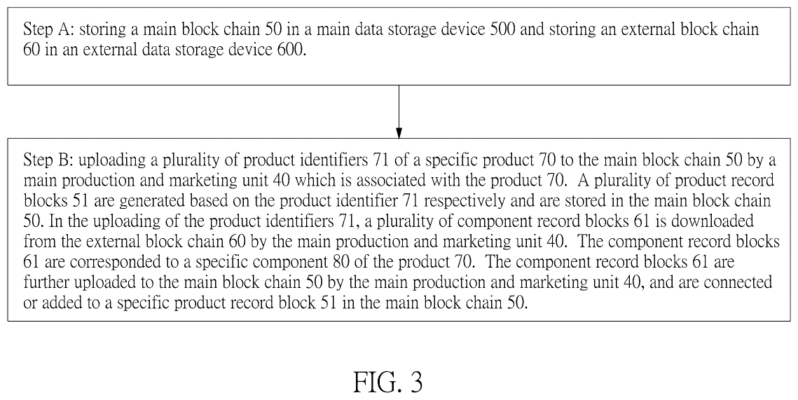

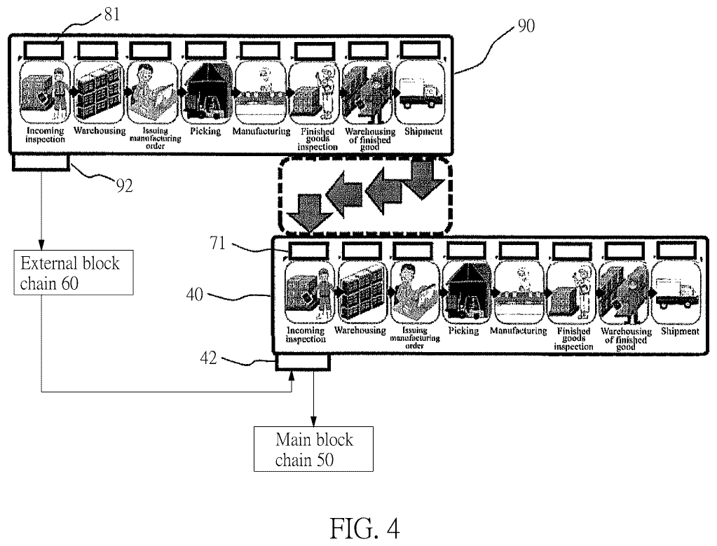

With reference to FIGS. 1 to 11, the present invention provides a method for tracking a product history. Referring to FIGS. 3 and 4, the method comprising the following steps of:

Step A: storing a main block chain 50 in a main data storage system 500 and storing an external block chain 60 in an external data storage system 600.

The main block chain 50 and the external block chain 60 serve to store a plurality of data records which are securely linked together. The main block chain 50 and the external block chain 60 can be respectively established and stored in the main data storage system 500 and the external data storage system 600 by peer-to-peer (P2P) computer networks, which are well-known prior arts. The main data storage system 500 and the external data storage system 600 may be distributed storage systems or any known computer storage systems. Therefore, the detail of the structures of the main block chain 50 and the external block chain 60 is not explained in the present invention.

Step B: uploading a plurality of product identifiers 71 of a specific product 70 to the main block chain 50 by a main production and marketing unit 40 which is associated with the specific product 70. A plurality of product record blocks 51 are generated based on the product identifiers 71 respectively and are stored in the main block chain 50.

In the step B, in the uploading of the product identifiers 71, a plurality of component record blocks 61 are downloaded from the external block chain 60 by the main production and marketing unit 40. The component record blocks 61 are corresponded to a specific component 80 of the product 70. The component record blocks 61 are further uploaded to the main block chain 50 by the main production and marketing unit 40, and are connected or added to a specific product record block 51 in the main block chain 50.

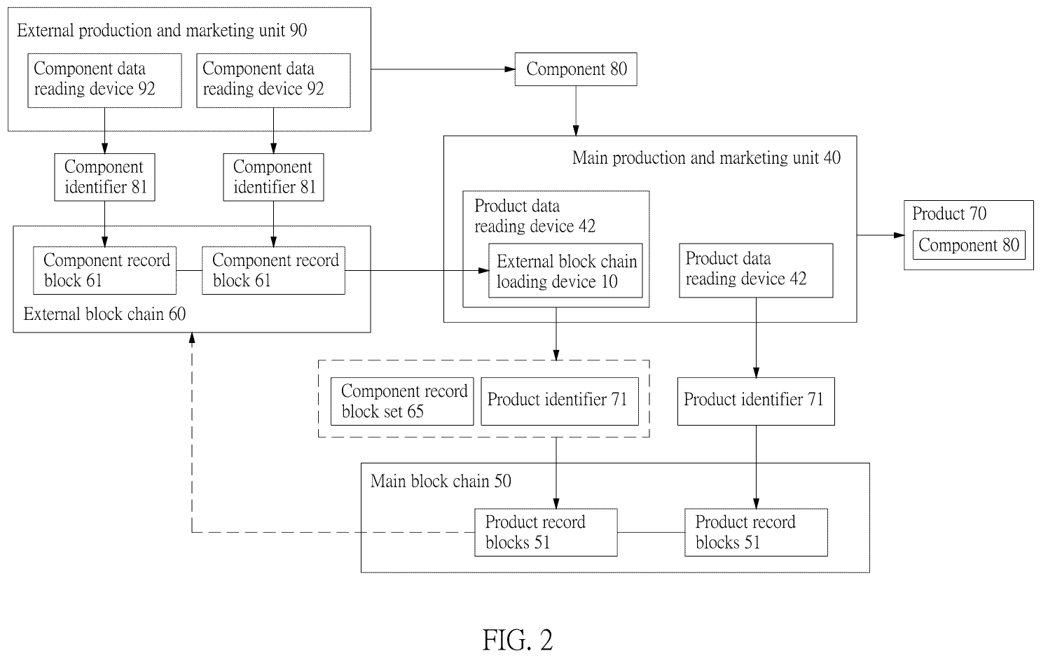

Referring to FIGS. 1 and 2, the present invention also provides a product history tracking system for performing above method. The product history tracking system includes the following elements.

The main block chain 50 stored in the main data storage system 500.

The external block chain 60 stored in the external data storage system 600.

The main production and marketing unit which is associated with the product 70. The main production and marketing unit is connected to the main data storage system 500 and the external data storage system 600. The main production and marketing unit serves to upload the product identifiers 71 of the product 70 to the main block chain 50. The product record blocks 51 are generated based on the product identifiers 71 respectively and are stored in the main block chain 50.

When the main production and marketing unit uploads the product identifiers 71 to the main block chain 50, the component record blocks 61 are downloaded from the external block chain 60 by the main production and marketing unit 40. The component record blocks 61 are corresponded to the component 80 of the product 70. The component record blocks 61 are further uploaded to the main block chain 50 by the main production and marketing unit 40, and are connected or added to a specific product record block 51 in the main block chain 50.

The product record blocks 51 are linked in series in the main block chain 50. Each of the product record blocks 51 has an encryption hash and a time stamp associated to a corresponding product identifier 71, and a transaction data of a previous linked product record block 51.

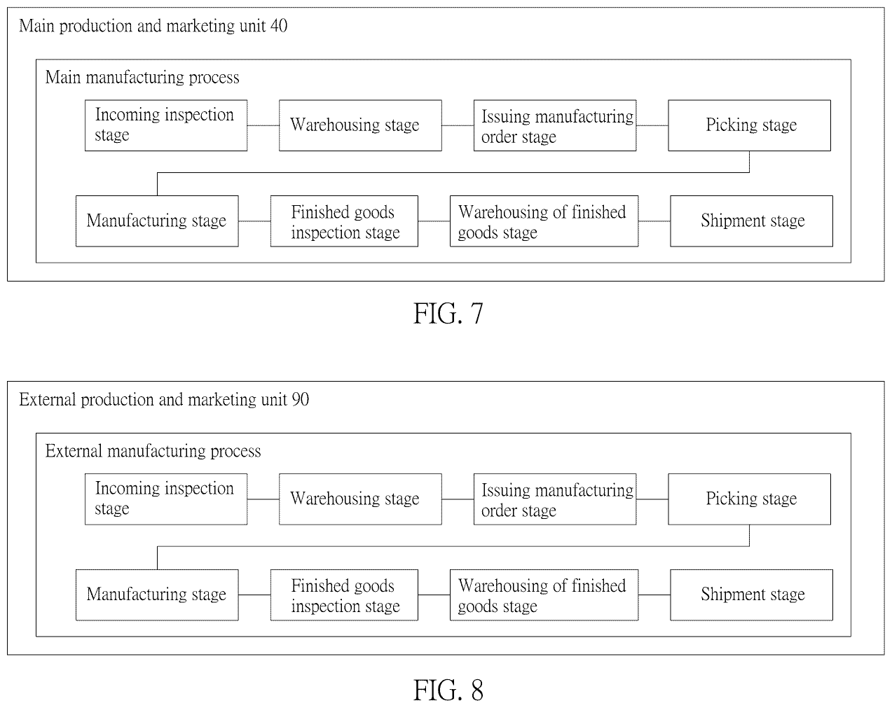

Referring to FIG. 7, the main production and marketing unit 40 serves to perform a main manufacturing process for the product 70. The main manufacturing process has a plurality of producing stages which include an incoming inspection stage (initial producing stage), a warehousing stage, an issuing manufacturing order stage, a picking stage, a manufacturing stage, a finished goods inspection stage, a warehousing of finished goods stage, and a shipment stage (final producing stage).

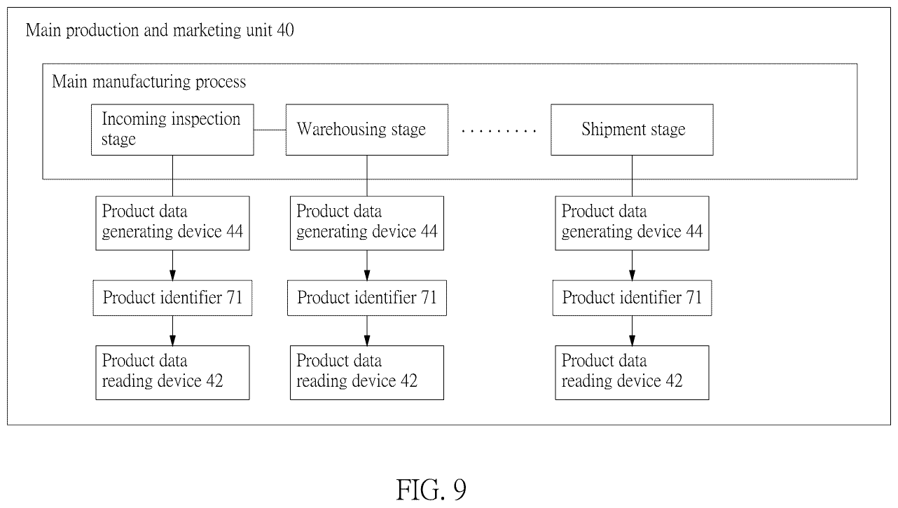

Referring to FIG. 9, the main production and marketing unit 40 includes a plurality of product data generating devices 44 and a plurality of product data reading devices 42. The product identifiers 71 are uploaded to the main block chain 50 by the product data reading devices 42.

Each of the producing stages of the main manufacturing process of the main production and marketing unit 40 is corresponded to a corresponding identification data generating device 14 and a corresponding product data reading device 42. Each of the product identifiers 71 is generated by a corresponding product data generating device 44 in a corresponding producing stage of the main manufacturing process to be assigned to the product 70. Each of the product data reading devices 42 serves to read a corresponding product identifier 71 in the corresponding producing stage and upload the corresponding product identifier 71 to the main block chain 50. The product identifiers 71 uploaded to the main block chain 50 are encrypted to generate the product record blocks 51.

The component record blocks 61 are respectively generated based on a plurality of component identifiers 81 of the component 80. The component record blocks 61 are linked in series in the external block chain 60. Each of the component record blocks 61 has an encryption hash and a time stamp associated to a corresponding component identifier 81, and a transaction data of a previous linked component record block 61.

The component record blocks 61 are uploaded to the external block chain 60 by an external production and marketing unit 90. The external production and marketing unit 90 serves to perform an external manufacturing process for the component 80. The component 80 produced by the external manufacturing process is outputted by the external production and marketing unit 90 to the main production and marketing unit 40 to be combined to the product 70 in the main manufacturing process of the main production and marketing unit 40.

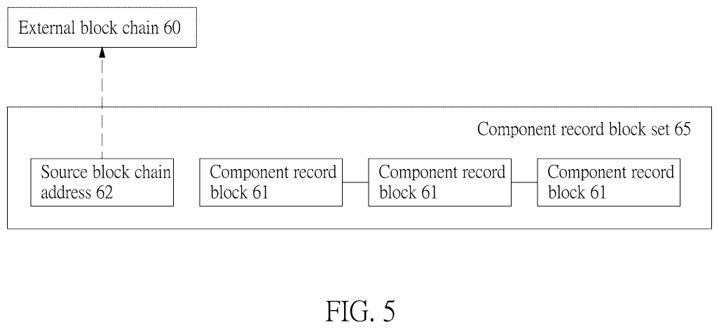

Referring to FIGS. 2 and 5, an external block chain loading device 10 is installed in one of the product data reading devices 42 of the main production and marketing unit 40. The external block chain loading device 10 is connected to external block chain 60 and serves to download the component record blocks 61 of the external block chain 60 into the main production and marketing unit 40. The product data reading devices 42 having the external block chain loading device 10 serves to upload a corresponding product identifier 71 with a component record block set 65 to the main block chain 50, wherein the component record block set 65 is formed by the component record blocks 61 and a source block chain address 62. The source block chain address 62 is an address of the external block chain 60 having the component record blocks 61. The product identifier 71 and the component record block set 65 are encrypted to generate a corresponding product record block 51 in the main block chain 50.

Each of the product identifiers 71 and the component identifiers 81 is an application identifier, which is a textual or graphical data formed by a specific coding rule. The application identifier is published by the barcode publishing and management organization. The product identifier 71 serves to record various data of the product 70, including category, batch, manufacturing date and others.

For example, each of the product identifiers 71 and the component identifiers 81 is a GS1 (Global Standard One) application identifier. The GS1 application identifiers include GTIN (Global Trade Item Number), SSCC (Serial Shipping Container Code), GLN (Global Location Number), GRAI (Global Returnable Asset Identifier) and GIAI (Global Individual Asset Identifier).

Referring to FIG. 8, the external manufacturing process has a plurality of producing stages which include an incoming inspection stage (initial producing stage), a warehousing stage, an issuing manufacturing order stage, a picking stage, a manufacturing stage, a finished goods inspection stage, a warehousing of finished goods stage, and a shipment stage (final producing stage).

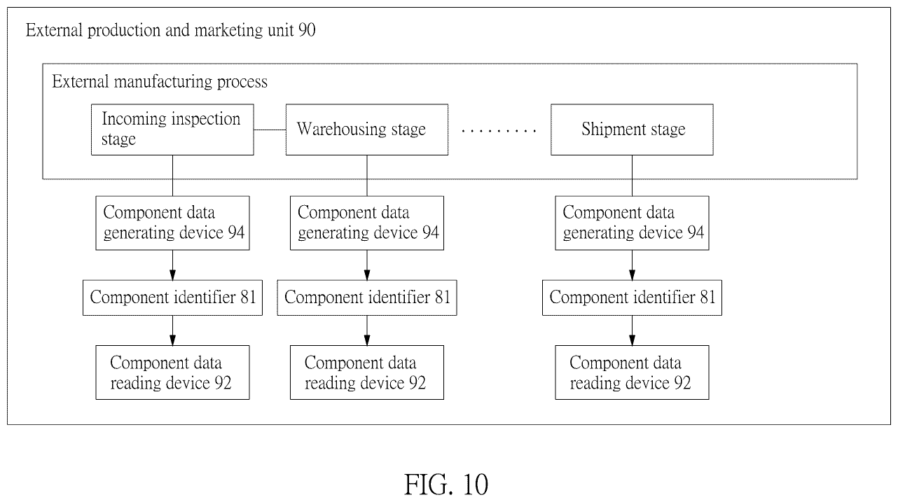

Referring to FIG. 10, the external production and marketing unit 90 includes a plurality of component data generating devices 94 and a plurality of component data reading devices 92. The component identifiers 81 are uploaded to the external block chain 60 by the component data reading devices 92.

Each of the producing stages of the external manufacturing process of the external production and marketing unit 90 is corresponded to a corresponding component data generating device 94 and a corresponding component data reading device 92. Each of the component identifiers 81 is generated by a corresponding component data generating device 94 in a corresponding producing stage of the external manufacturing process to be assigned to the component 80. Each of the component data reading devices 92 serves to read a corresponding component identifier 81 in the corresponding producing stage of the external manufacturing process and upload the corresponding component identifier 81 to the external block chain 60. The component identifiers 81 uploaded to the external block chain 60 are encrypted to generate the component record blocks 61.

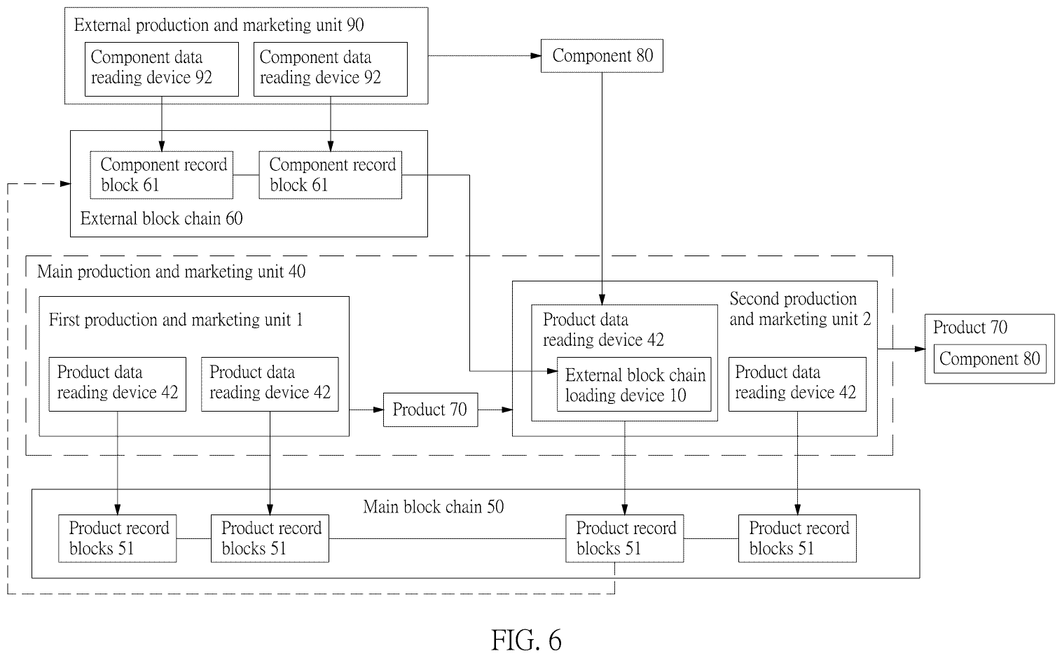

Referring to FIG. 6, the main production and marketing unit 40 is formed by a first production and marketing unit 1 and a second production and marketing unit 2. The main manufacturing process of the main production and marketing unit 40 is performed by a first manufacturing process of the first production and marketing unit 1 and a second manufacturing process of the second production and marketing unit 2.

The product 70 is outputted by the first manufacturing process of the first production and marketing unit 1 to be inputted into the second production and marketing unit 2. The component 80 produced by the external production and marketing unit 90 is also inputted to the second production and marketing unit 2. The external block chain loading device 10 is installed in a corresponding product data reading device 42 in the second production and marketing unit 2 for obtaining the component record blocks 61 and the source block chain address 62 of the external block chain 60. The component record blocks 61 and the source block chain address 62 are uploaded as the component record block set 65 with a corresponding product identifier 71 by the corresponding product data reading device 42 of the second production and marketing unit 2 to the main block chain 50.

With above way, the component record blocks 61 of the external block chain 60 can be loaded and stored into the product record block 51 of the main block chain 50 at a specific producing stage of the main manufacturing process of the main production and marketing unit 40. As a result, the identification data of different components of the product in different multiple production and marketing units can be stored into different separated block chains, and the record blocks of these different separated block chains can be respectively merged together in corresponding producing stages of an entire manufacturing process, which has a better extensibility of combining data of the block chains and ensures that data of these components of the product are difficult to tamper with.

The block chain is a serial transaction records for protecting contents. Each block includes hashing encryptions, respective time stamps, and transaction records of a former block. As a result, the contents of the blocks are very difficult to be modified. The distributed accounts generated by block chains have the property of effective recording and the transaction records can be checked permanently. The best advantage of the block chain is that it can be developed and provided by common platform. The enterprises (including competitors) of various industries must agree on a common standard and run a system so as to enjoy the maximum advantage of block chain.

The product identifiers 71 and the component identifiers 81 generated in the producing stages present the historical data of the product 70 and the component 80. Each producing stage in the manufacturing process use resources from a previous producing stage, which matches the design of the block chain mechanism because each block of the block chain also stores the information of a previous block. Therefore, by using the main block chain 50 and the external block chain 60 which are de-centralized structures, the historical data about the product 70 and the component 80 can be more unified.

Each of the product identifiers 71 and the component identifiers 81 also can be application identifier including the information of documents, contracts, transportation of goods, supplementary identification data, expiration date, unit of weights and measures, material suppliers, product manufacturers, retailers, warehousers, logisticians and distributors.

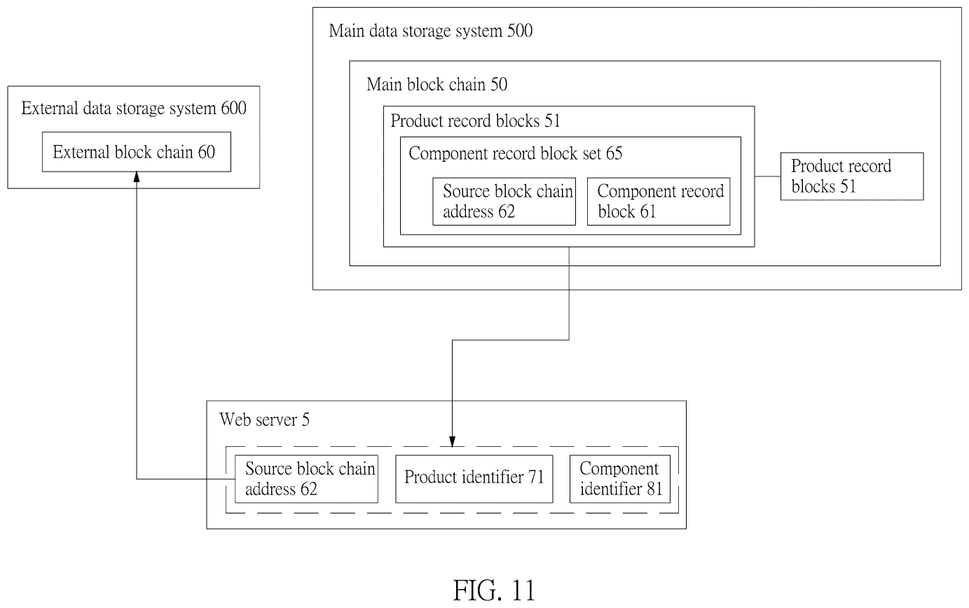

With reference to FIG. 11, the main data storage system 500 is connected to a web server 5. When the web server 5 receives a request of an external consumers or inspection authority, the web server 5 decrypts the product identifier 71 and the component identifier 81 from the product record blocks 51 of the main block chain 50, and outputs the product identifier 71 and the component identifier 81 to the external consumers or inspection authority for checking and inspecting. The web server 5 also serves to link to the external data storage system 600 through the source block chain address 62 stored in the main block chain 50 to obtain required data of the component 80 from the external block chain 60.

Preferably, the main block chain 50 or the external block chain 60 is formed as a public block chain platform by using Ethereum to provide decentralized virtual machine for processing reciprocal contracts.

The advantages of the present invention are that, different block chains are used for storing the identifiers of various components of the product. In the manufacturing of the product, the component identifiers in the producing stages of manufacturing process of each component are uploaded to a corresponding external block chain. When each component is inputted to the main production and marketing unit to be assembled into the product, the component identifiers in each external block chain are respectively loaded into the main production and marketing unit and are uploaded with the product identifiers to the main block chain. Because each identifier represents a respective producing stage of the manufacturing of the component and the product, the identifiers stored in the main block chain can represent a full product history including the full component history. The production and marketing units of these component can use different identifier standards for storing its own component identifiers in a corresponding block chain with a specific identifier standard. By using the external block chain loading device in the main production and marketing unit, the component identifiers of different components can be easily downloaded from different external block chains and uploaded to the main block chain for forming a full product history including the full component history. By uploading the identifiers of product and its components, the historical data of the product and its components can be checked and tracked.

As a result, the identifiers of the product and its components are combined with multiple block chains to develop a multi-level product history. The historical data of each component can be searched in a specific product record block of the main block chain, which assures that searching can be performed during processes of manufacturing, warehousing and distributions and sales without being modified. The external block chain for each component also can be accessed by the source block chain address stored with the historical data of each component, which allows a high degree of scalability of the historical data and assuring a high reliability of the quality of the product and its components simultaneously.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for tracking a product history, comprising the steps of:
step A: storing a main block chain in a main data storage system and storing an external block chain in an external data storage system;
step B: uploading a plurality of product identifiers of a specific product to the main block chain by a main production and marketing unit which is associated with the product; a plurality of product record blocks are generated based on the product identifiers respectively and are stored in the main block chain; and
wherein in the step B, in the uploading of the product identifiers, a plurality of component record blocks are downloaded from the external block chain by the main production and marketing unit; the component record blocks are corresponded to a specific component of the product; and the component record blocks are further uploaded to the main block chain by the main production and marketing unit, and are connected or added to a specific product record block in the main block chain.

2. The method for tracking the product history as claimed in claim 1, wherein the product record blocks are linked in series in the main block chain; each of the product record blocks has an encryption hash and a time stamp associated to a corresponding product identifier, and a transaction data of a previous linked product record block; and
wherein the component record blocks are respectively generated based on a plurality of component identifiers of the component; the component record blocks are linked in series in the external block chain; and each of the component record blocks has an encryption hash and a time stamp associated to a corresponding component identifier, and a transaction data of a previous linked component record block.

3. The method for tracking the product history as claimed in claim 2, wherein the main production and marketing unit serves to perform a main manufacturing process for the product; the main manufacturing process has a plurality of producing stages; the main production and marketing unit includes a plurality of product data generating devices and a plurality of product data reading devices; the product identifiers are uploaded to the main block chain by the product data reading devices;
wherein each of the producing stages of the main manufacturing process of the main production and marketing unit is corresponded to a corresponding identification data generating device and a corresponding product data reading device; each of the product identifiers is generated by a corresponding product data generating device in a corresponding producing stage of the main manufacturing process to be assigned to the product; each of the product data reading devices serves to read a corresponding product identifier in the corresponding producing stage and upload the corresponding product identifier to the main block chain; the product identifiers uploaded to the main block chain are encrypted to generate the product record blocks; and
wherein an external block chain loading device is installed in one of the product data reading devices of the main production and marketing unit; the external block chain loading device is connected to external block chain and serves to download the component record blocks of the external block chain into the main production and marketing unit; the product data reading devices having the external block chain loading device serves to upload a corresponding product identifier with a component record block set to the main block chain, wherein the component record block set is formed by the component record blocks and a source block chain address; the source block chain address is an address of the external block chain having the component record blocks; and the product identifier and the component record block set are encrypted to generate a corresponding product record block in the main block chain.

4. The method for tracking the product history as claimed in claim 3, wherein the component record blocks are uploaded to the external block chain by an external production and marketing unit; the external production and marketing unit serves to perform an external manufacturing process for the component; the component produced by the external manufacturing process is outputted by the external production and marketing unit to the main production and marketing unit to be combined to the product in the main manufacturing process of the main production and marketing unit; the external manufacturing process has a plurality of producing stages; the external production and marketing unit includes a plurality of component data generating devices and a plurality of component data reading devices; the component identifiers are uploaded to the external block chain by the component data reading devices; and
wherein each of the producing stages of the external manufacturing process of the external production and marketing unit is corresponded to a corresponding component data generating device and a corresponding component data reading device; each of the component identifiers is generated by a corresponding component data generating device in a corresponding producing stage of the external manufacturing process to be assigned to the component; each of the component data reading devices serves to read a corresponding component identifier in the corresponding producing stage of the external manufacturing process and upload the corresponding component identifier to the external block chain; and the component identifiers uploaded to the external block chain are encrypted to generate the component record blocks.

5. The method for tracking the product history as claimed in claim 1, wherein each of the product identifiers and the component identifiers is an application identifier, which is a textual or graphical data formed by a specific coding rule.

6. The method for tracking the product history as claimed in claim 1, wherein each of the product identifiers and the component identifiers is a GS1 (Global Standard One) application identifier.

7. The method for tracking the product history as claimed in claim 3, wherein the main production and marketing unit is formed by a first production and marketing unit and a second production and marketing unit; the main manufacturing process of the main production and marketing unit is performed by a first manufacturing process of the first production and marketing unit and a second manufacturing process of the second production and marketing unit; and
wherein the product is outputted from the first manufacturing process of the first production and marketing unit to be inputted into the second production and marketing unit; the component produced by the external production and marketing unit is inputted to the second production and marketing unit; the external block chain loading device is installed in a corresponding product data reading device in the second production and marketing unit for obtaining the component record blocks and the source block chain address of the external block chain; the component record blocks and the source block chain address are uploaded as the component record block set with a corresponding product identifier by the corresponding product data reading device of the second production and marketing unit to the main block chain.

8. The method for tracking the product history as claimed in claim 3, wherein the main data storage system is connected to a web server; when the web server receives a request of an external consumers or inspection authority, the web server decrypts the product identifier and the component identifier from the product record blocks of the main block chain, and outputs the product identifier and the component identifier to the external consumers or inspection authority for checking and inspecting; and the web server serves to connect the external data storage system through the source block chain address stored in the main block chain to obtain required data of the component from the external block chain.

9. A product history tracking system, comprising:
a main block chain stored in a main data storage system;
an external block chain stored in an external data storage system;
a main production and marketing unit which is associated with a specific product; the main production and marketing unit being connected to the main data storage system and the external data storage system; the main production and marketing unit serving to upload a plurality of product identifiers of the product to the main block chain; a plurality of product record blocks generated based on the product identifiers respectively and stored in the main block chain; and
wherein when the main production and marketing unit uploads the product identifiers to the main block chain, a plurality of component record blocks are downloaded from an external block chain by the main production and marketing unit; the component record blocks are corresponded to a specific component of the product; and the component record blocks are further uploaded to the main block chain by the main production and marketing unit, and are connected or added to a specific product record block in the main block chain.

10. The product history tracking system as claimed in claim 9, wherein the product record blocks are linked in series in the main block chain; each of the product record blocks has an encryption hash and a time stamp associated to a corresponding product identifier, and a transaction data of a previous linked product record block; and
wherein the component record blocks are respectively generated based on a plurality of component identifiers of the component; the component record blocks are linked in series in the external block chain; and each of the component record blocks has an encryption hash and a time stamp associated to a corresponding component identifier, and a transaction data of a previous linked component record block.

11. The product history tracking system as claimed in claim 10, wherein the main production and marketing unit serves to perform a main manufacturing process for the product; the main manufacturing process has a plurality of producing stages; the main production and marketing unit includes a plurality of product data generating devices and a plurality of product data reading devices; the product identifiers are uploaded to the main block chain by the product data reading devices;
wherein each of the producing stages of the main manufacturing process of the main production and marketing unit is corresponded to a corresponding identification data generating device and a corresponding product data reading device; each of the product identifiers is generated by a corresponding product data generating device in a corresponding producing stage of the main manufacturing process to be assigned to the product; each of the product data reading devices serves to read a corresponding product identifier in the corresponding producing stage and upload the corresponding product identifier to the main block chain; the product identifiers uploaded to the main block chain are encrypted to generate the product record blocks; and
wherein an external block chain loading device is installed in one of the product data reading devices of the main production and marketing unit; the external block chain loading device is connected to external block chain and serves to download the component record blocks of the external block chain into the main production and marketing unit; the product data reading devices having the external block chain loading device serves to upload a corresponding product identifier with a component record block set to the main block chain, wherein the component record block set is formed by the component record blocks and a source block chain address; the source block chain address is an address of the external block chain having the component record blocks; and the product identifier and the component record block set are encrypted to generate a corresponding product record block in the main block chain.
